(19) United States
(12) Patent Application Publication
(10) Pub. No.: US 2021/0133376 A1
(43) Pub. Date: May 6, 2021

(54) SYSTEMS AND METHODS OF PARAMETER CALIBRATION FOR DYNAMIC MODELS OF ELECTRIC POWER SYSTEMS

(71) Applicants: Global Energy Interconnection Research Institute Co. Ltd, Beijing (CN); State Grid Corporation of China Co. Ltd, Beijing (CN); State Grid Jiangsu Electric Power Co., LTD., Nanjing (CN); State Grid ShanXi Electric Power Company, Jinan (CN)

(72) Inventors: Siqi Wang, San Jose, CA (US); Ruisheng Diao, San Jose, CA (US); Xiao Lu, San Jose, CA (US); Di Shi, San Jose, CA (US)

(21) Appl. No.: 17/089,444

(22) Filed: Nov. 4, 2020

Related U.S. Application Data
(60) Provisional application No. 62/930,152, filed on Nov. 4, 2019.

(51) Int. Cl. G06F 30/27; G06N 3/08

(52) U.S. Cl. CPC G06F 30/27; G06F 2113/04; G06N 3/08

(57) ABSTRACT

Autonomous parameter calibration for a model of an electric power system includes inputting electric measurements, simulating the model with a set of parameters to generate a first simulated response, identifying a first and a second parameter in the set of parameters, the first parameter being responsible for a deviation of the first simulated response from the electric measurements, while the second parameter being not responsible to the deviation, generating an action corresponding to the first parameter by a DRL agent based on the deviation, modifying the first parameter by the generated action while leaving the second parameter unmodified, simulating the model again with the set of parameters including the modified first parameter and the unmodified second parameter to generate a second simulated response, evaluating a fitting error between the second simulated response and the electric measurements, and terminating the parameter calibration when the fitting error falls below a predetermined threshold.

### CROSS-REFERENCE TO RELATED APPLICATIONS

This application claims priority to and the benefit of U.S. Provisional Application No. 62/930,152 filed on Nov. 4, 2019 and entitled “AI-aided Automated Dynamic Model Validation and Parameter Calibration Platform,” and is herein incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in drawings that form a part of this document: Copyright, GEIRI North America, All Rights Reserved.

### FIELD OF TECHNOLOGY

The present disclosure generally relates to electric power transmission and distribution system, and, more particularly, to systems and methods of automated dynamic model validation and parameter calibration for electric power systems.

### BACKGROUND OF TECHNOLOGY

In today's practice, decision making for power system planning and operation heavily relies on results of high-fidelity transient stability simulations. In such simulations, dynamic models in the form of differential algebra equations (DAEs) are widely adopted to describe the dynamic performance of various system components under disturbances. Any large inconsistency between simulation and reality can lead to incorrect engineering judgment and may eventually cause severe system-wide outages following large disturbances. Historical events including the 1996 WSCC system breakup event and the 2011 Southwestern U.S. blackout have shown that dynamic-model-based simulations can fail to reveal actual system responses and make incorrect predictions, due to modeling and parameter issues (North American Electric Reliability Corporation, “Power System Model Validation,”[Online].Available: https://www.nerc.com/comm/PC/Model %20Validation %20Working %20Group %20MV WG/MV %20White %20Paper_Final.pdf, and Y. Li, et al., “An innovative software tool suite for power plant model validation and parameter calibration using PMU measurements,” IEEE PES General Meeting, Chicago, Ill., 2017, pp. 1-5). Since then, WSCC and NERC launched a number of standards (MOD 26, 27 and 33) requiring that all generators with a capacity greater than a threshold (e.g., 75 MVA for WECC and ERCOT in North America) be validated, at least once every five years (D. Kosterev and D. Davies, “System model validation studies in WECC,” IEEE PES General Meeting, Providence, R.I., 2010, pp. 1-4) for improving overall model quality.

Stability models, as essential components for power system operation and planning study, are used to describe the power system's dynamic performance. As the accuracy of system dynamic response highly relies on the validity of its underlying models, dynamic model validation is becoming more and more important in recent years. The conventional model validation approach is usually costly, less effective and less accurate (S. Wang, E. Farantatos and K. Tomsovic, “Wind turbine generator modeling considerations for stability studies of weak systems,” 2017 North American Power Symposium (NAPS), Morgantown, W. Va., 2017, pp. 1-6). For example, conventional generator model validation is conducted through staged tests, which requires generators being taken offline and not able to produce electricity for revenue. The fast-growing deployment of phasor measurement units (PMUs) in recent years provides a low-cost alternative that uses recorded disturbance data to validate and calibrate stability models without taking generators offline. Various software vendors' packages have developed model validation modules using play-in signals, including TSAT, PSS/E, PSLF and PowerWorld (“Model validation using phasor measurement unit data”. NASPI technical report. [Online]. Available: https://www.naspi.org/node/370). Voltage magnitude and frequency (or phase angle) curves are used as inputs to drive dynamics of models; while simulated active and reactive power curves are used as outputs to compare with actual measurements. In case of large errors between simulated response and actual measurements, parameter calibration process is usually needed, with the main objective of deriving one model parameter set that can minimize such errors for various system events.

To achieve this goal, various methods and algorithms were reported, including nonlinear least square method for curve fitting (P. Pourbeik, “Approaches to validation of power system models for system planning studies,” IEEE PES General Meeting, Providence, R.I., 2010, pp. 1-10), Kalman Filter based algorithms (R. Huang et al., “Calibrating Parameters of Power System Stability Models Using Advanced Ensemble Kalman Filter,” IEEE Transactions on Power Systems, vol. 33, no. 3, pp. 2895-2905, May 2018), maximum likelihood methods (I. A. Hiskens, “Nonlinear dynamic model evaluation from disturbance measurements,” IEEE Trans. Power Systems, vol. 16, no. 4, pp. 702-710, November 2001), genetic algorithms (GA) (J. Y. Wen et al, “Power system load modeling by learning based on system measurements,” IEEE Trans. Power Delivery, vol. 18, no. 2, pp. 364-371, April 2003) and particle swarm optimization (PSO) methods (P. Regulski, et al., “Estimation of Composite Load Model Parameters Using an Improved Particle Swarm Optimization Method,” IEEE Trans. Power Delivery, vol. 30, no. 2, pp. 553-560, April 2015).

In general, conventional online model validation methods are usually optimization-based parameter estimation methods. A general idea is to search for the optimal parameters in order to minimize the error between the estimated response and the actual response. Among aforementioned approaches, two limitations are identified, including: (1) the Kalman filter-based or optimization-based approaches try to find an optimal parameter set for a single event only, which may not work well for other events given the fact that multiple solutions may exist when calibrating parameters to fit actual measurements; and (2) it requires a significant amount of efforts to adapt these algorithms individually to hundreds of stability models used in today's practice, i.e., modification of source code of the models, thus, limiting their real-world deployment.

Different from conventional approaches, artificial intelligent (AI) based algorithms are gaining more and more attention recently. For example, in Q. Huang, R. Huang, W. Hao, J. Tan, R. Fan and Z. Huang, “Adaptive Power System Emergency Control using Deep Reinforcement Learning,” in IEEE Transactions on Smart Grid, an adaptive emergency control scheme using deep reinforcement learning (DRL) is proposed for power system control. A neural network (NN) based approach for power system frequency prediction is proposed in D. Zografos, T. Rabuzin, M. Ghandhari and R. Eriksson, “Prediction of Frequency Nadir by Employing a Neural Network Approach,” 2018 IEEE PES Innovative Smart Grid Technologies Conference Europe (ISGT-Europe), Sarajevo, 2018, pp. 1-6. A Convolutional Neural Network (CNN) based approach is adopted for voltage stability analysis in Y. Wang, H. Pulgar-Painemal and K. Sun, “Online analysis of voltage security in a microgrid using convolutional neural networks,” 2017 IEEE Power & Energy Society General Meeting, Chicago, Ill., 2017, pp. 1-5. While AI-based approach has been widely used in power industry such as in control, monitoring and stability analysis, AI-based approach for power system modeling, especially for model validation has not been addressed thoroughly and has great potential.

As such, what is desired is automated dynamic model validation and parameter calibration platform that can automate model tuning processes and at the same time enhance the model accuracy.

### SUMMARY OF DESCRIBED SUBJECT MATTER

The presently disclosed embodiments relate to systems and methods of a deep reinforcement learning (DRL) aided multi-layer stability model calibration platform for electric power systems.

In some embodiments, the present disclosure provides an exemplary technically improved computer-based autonomous parameter calibration systems and methods that include inputting electric measurements from the electric power system, simulating the model with a set of parameters to generate a first simulated response, identifying a first and a second parameter in the set of parameters, the first parameter being responsible for a deviation of the first simulated response from the electric measurements, while the second parameter being not responsible to the deviation, generating a first action corresponding to the first parameter by a deep reinforcement learning (DRL) agent based on the deviation, modifying the first parameter by the generated first action while leaving the second parameter unmodified, simulating the model again with the set of parameters including the modified first parameter and the unmodified second parameter to generate a second simulated response, evaluating a fitting error between the second simulated response and the electric measurements, and terminating the parameter calibration when the fitting error falls below a predetermined threshold.

In some embodiments, the present disclosure provides an exemplary technically improved computer-based autonomous parameter calibration systems and methods that include activating a first deep reinforcement learning (DRL) agent to optimally adjust a predetermined parameter of a set of parameters for the model with a first action step size, activating a second DRL agent to further optimally adjust the predetermined parameter with a second action step size smaller than the first action step size, and terminating the parameter calibration when a fitting error between a model simulated response and the electric measurements falls below a predetermined threshold.

In some embodiments, the present disclosure provides an exemplary technically improved computer-based autonomous parameter calibration systems and methods that run either a deep Q network (DQN) algorithm or a soft actor critic (SAC) algorithm for model parameter optimization.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIGS. 1-14 show one or more schematic flow diagrams, certain computer-based architectures, and/or computer-generated plots which are illustrative of some exemplary aspects of at least some embodiments of the present disclosure.

FIG. 1 shows a block diagram of an automated parameter calibration platform in accordance with embodiments of the present disclosure.

FIG. 2 shows s a flowchart illustrating a model validation process in accordance with embodiments of the present disclosure.

FIG. 3 shows a flowchart illustrating an overall model validation and parameter calibration process according to embodiments of the present disclosure.

FIG. 4 shows a flowchart illustrating an optimization process by agent L1.

FIG. 5 shows a flowchart illustrating an optimization process by agent L2.

FIG. 6 conceptually illustrates model validation and parameter calibration with play-in signals.

FIG. 7 shows mismatches between model and actual measurements.

FIG. 8 shows level 1 training results.

FIG. 9 shows level 2 cumulative rewards.

FIG. 10 shows active and reactive power responses with the DQN calibrated parameter set.

FIG. 11 shows performance of a test event using the calibrated parameters.

FIG. 12 also shows mismatches between model and actual measurements.

FIG. 13A shows SAC train loss.

FIG. 13B shows SAC cumulative reward.

FIG. 14 shows active and reactive power responses with the SAC calibrated parameter set.

### DETAILED DESCRIPTION

The present disclosure relates to a deep reinforcement learning (DRL) aided multi-layer stability model calibration platform for electric power systems. Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

The present disclosure presents a novel DRL-based parameter calibration platform for stability models, which employs multi-layer DRL agents with adaptive action step sizes to automate the parameter calibration process for multiple events. Through massive interactions with the simulation environment (commercial transient stability simulators without the need of modifying existing models), reinforcement learning (RL) agents can learn to find the best parameters that minimize the overall fitting errors between the measured response and simulated response of multiple events and continue to adaptively update their policies for better parameters until convergence. In an embodiment, the convergence is defined as the loss of the policy being less than a predetermined threshold which is usually set at 10E-4. The proposed DRL-based process can serve multiple objectives, simultaneously consider multiple events and derive optimal parameter sets from random initial conditions.

The present disclosure is organized as follows. Section I provides an overview of the platform in accordance with embodiments of the present disclosure and its key functions. Section II introduces details of the core DRL-based parameter calibration procedure with two embodiments and respective case studies to verify the proposed methodologies.

Section I. Overview of the Platform

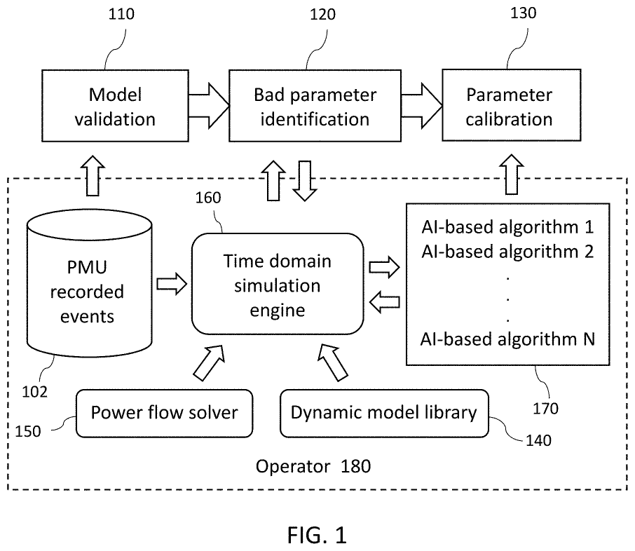

FIG. 1 shows a block diagram of an automated parameter calibration platform in accordance with embodiments of the present disclosure. The proposed platform has following three key modules.

(1) Model Validation Module 110

In the model validation module 110, the input information contains power flow files, dynamic model files and PMU measurements for multiple recorded events. Recorded measurements with events are first played into the dynamic simulation environment to launch the model validation process. If there is no obvious mismatch between the simulated and the measured responses, the existing model is considered as valid and no calibration is necessary. Otherwise, parameters that need to be updated are selected by the bad parameter identification module.

(2) Bad Parameter Identification Module 120

Since calibrating all parameters in stability models simultaneously can make the searching progress slow and ineffective, the bad parameter identification module 120 pre-screens the parameter set to identify problematic ones that contribute most to the model inaccuracy. Both engineering judgment and sensitivity based methods can be used to achieve this goal (Y. Li, et al., “An innovative software tool suite for power plant model validation and parameter calibration using PMU measurements,” IEEE PES General Meeting, Chicago, Ill., 2017, pp. 1-5). In addition, valid ranges of the identified parameters for calibration can be collected from P. Kundur, Power System Stability and Control New York: McGraw-Hill 1994.

(3) Parameter Calibration Module 130

The parameter calibration module 130 is DRL-based according to embodiments of the present disclosure, and adopts a multi-layer structure to enable coarse-fine search of parameter sets with adaptive step sizes. In some embodiments, a DRL agent is trained for a coarse level (L1) with large action step sizes, and another DRL agent is trained for a fine level (L2) with small action step sizes. Agent L1 is activated to search for the best initial conditions to improve efficiency in training agent L2, which then continues to search for the best fit with a smaller step size. In some embodiments, more levels can be added if necessary, without loss of generality. The calibrated parameters are sent back to the model validation module 110 for further verification considering multiple events. This process continues until a satisfactory parameter set is identified.

In general, an AI agent needs an initial condition (initial dynamic model parameter set) to start its search for better model parameter sets. In some embodiments of the present disclosure, if a user already has some knowledge about the dynamic model parameters, i.e., the user is aware some parameters may be close to certain values, then the best initial condition is considered known, agent L1 can be bypassed, and agent L2 can directly use these parameter values as the initial condition for agent L2 to conduct fine searches for more accurate parameters. In some embodiments of the present disclosure, if a user does not have knowledge of a good initial parameter set, then agent L1 will be initialized randomly with larger step size to conduct coarse searches for the best initial parameter set for agent L2. After receiving the best initial parameter set, agent L2 will be activated to perform the find searches for more accurate parameters.

The proposed platform also have following key components.

(1) Dynamic Model Library 140

The dynamic model library 140 contains various kinds of dynamic models, including but not limited to generator models, load models, exciter models, PSS models and a variety of power-electronic based renewable resources models. These models can be represented in a unified or customized data format that a time domain (TD) simulation engine 160 can recognize.

(2) Power Flow Solver 150

The power flow solver 150 finds the initial condition that a time domain engine 160 uses to calculate a simulated response. It may be included in the time domain engine 160 or can be in a separate package. The power flow solver 150 can load unified or customized power flow data files and solve the power flow to provide power flow results to both the TD simulation engine 160 and a runner which provides an input/output interface (input parser/output parser), and a user interface so that the user can choose which algorithm will be used and what parameters the agent will use, etc.

(3) Time Domain Simulation Engine (TD Engine) 160

The TD simulation engine 160 is used to perform time-domain simulations, which get the power flow results from power flow solver 150 and the dynamic models from a dynamic model library.

(4) Agent Container 170

The agent container 170 includes various kinds of AI-based algorithms 1 through N. Each algorithm is coded as a separate agent. Each agent has the capability of interacting with the environment, acquire information from the runner and perform the task assigned by the runner. In some embodiments, a deep Q network (DQN) algorithm is a core algorithm in the agent container 170. In some embodiments, a soft actor critic (SAC) algorithm is a core algorithm instead. The AI-based algorithms modify the dynamic model parameters supplied to the time domain simulation engine 160 which will compute a simulated response to the dynamic model parameters.

(5) Operator 180

The operator 180 controls data flow in the environment and exemplarily performs following duties:

A. call the TD simulation engine 160 to perform simulation;
B. acquire simulation results from the TD simulation engine 160, update model parameters and send parameters back to the TD simulation engine 160;
C. call the power flow solver 150 to solve power flow;
D. assign agents to perform model validation and parameter calibration task.

Referring again to FIG. 1, the DRL-based platform for model validation and parameter calibration in accordance with embodiments of the present disclosure includes following major components:
A time-domain (TD) simulation engine 160 to perform time-domain simulations;
An environment to create the simulation environment, to launch TD engine;
An agent container 170 to apply multiple AI-based algorithms, and plug them in to the environment; and
An operator 180 to activate the environment and call the agent to perform model validation process.

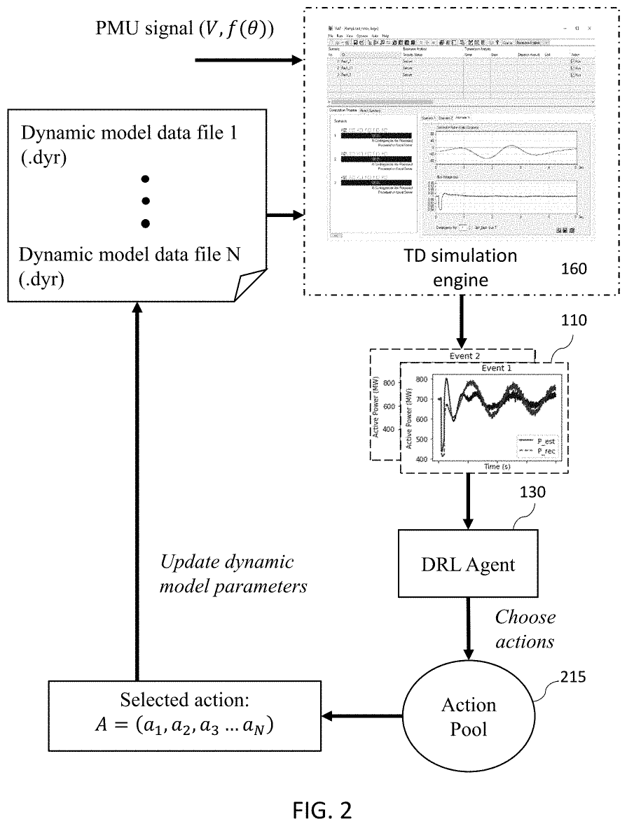

FIG. 2 shows s a flowchart illustrating a model validation process in accordance with embodiments of the present disclosure. In a loop, the TD simulation engine 160 receives both dynamic model data files and PMU signals for multiple recorded events to run time domain simulations. The simulation results will be evaluated by the model validation module 110. If a simulated response deviates from a measured response, then a corresponding dynamic model needs to be calibrated by the exemplary DRL agent 130. The DRL agent 130 chooses actions to modify parameters for the dynamic models. The chosen actions are stored in an action pool 215, and certain selected actions will be carried out to update the dynamic model parameters. With the updated parameters, the dynamic models will be simulated again by the TD simulation engine 160, and re-evaluated by the model validation module 110. Such looping process continues until the simulated response converges with the measured response.

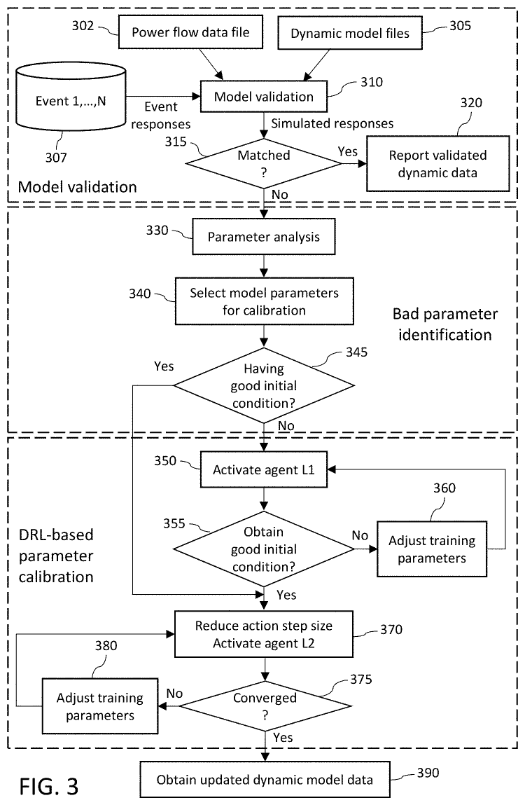

FIG. 3 shows a flowchart illustrating an overall model validation and parameter calibration process according to embodiments of the present disclosure. The model validation and parameter calibration process starts with a model validation step 310, in which power flow data files 302, dynamic model files 305 and multiple recorded event responses 307 from PMU measurements are inputted the model validation module 110 shown in FIG. 1. In step 315, simulated responses are compared with the measured responses. When an error between the simulated response curve and the PMU recorded response curve is smaller than, e.g., 10E-4, the responses are considered matched. In step 315, if the simulated responses match the measured responses, the model validation and parameter calibration process will report the original model is considered as valid and no parameter calibration process is needed in step 320. However, if mismatches occurs in step 315, the bad parameter identification module 120 shown in FIG. 1 will be engaged. In step 330, the model validation and parameter calibration process analyzes the parameter set and identifies those problematic ones that contribute most to the model errors that cause the mismatches. In step 340, only those problematic parameters are selected for calibration to reduce computational demand. In step 345, the model validation and parameter calibration process evaluates an initial condition for training DRL agents. For a particular set of dynamic model parameters, when the initial simulated response is not far away from the PMU measurements, i.e., the parameters before calibrating are close to the true parameters, then the initial condition is considered good. In this case, the process enters step 370 directly, where a DRL agent for training a fine level (L2) with small action step sizes will be activated. If the initial condition is not good, the process enters step 350 where a DRL agent for training a coarse level (L1) with large action step sizes is activated. Activated agent L1 searches for the best initial conditions to improve efficiency in training for the DRL agent for training the fine level (L2) with small action step sizes. Then the initial condition is evaluated again in step 355. If the initial condition is not good, training parameters for agent L2 will be adjusted in step 360 before returning to step 350. The DRL agent training parameters may include learning rate, exploration and exploitation rate and step size, etc. If the initial condition in step 355 becomes good, the model validation and parameter calibration process reduces action step size and activate agent L2 in step 370. Activated agent L2 searches to the best fitting parameter set with the smaller action step size. In step 375, convergence of the simulated response and the measured response is evaluated. When a training loss of the AI algorithm is stabilized and smaller than a predetermined threshold, e.g., 10E-4, the AI algorithm is considered converged and the solution is optimal. There are various types of loss, such as root mean square error (RMSE) and mean square error (MSE), that can serve as the training loss. In step 375, if a predetermined convergence level is not achieved, the evaluation process will adjust training parameters in step 380 and activate agent L2 to perform search again in step 370. If a satisfactory convergence is achieved in step 375, the model validation and parameter calibration process obtains updated dynamic model data in step 390 and accomplishes its mission.

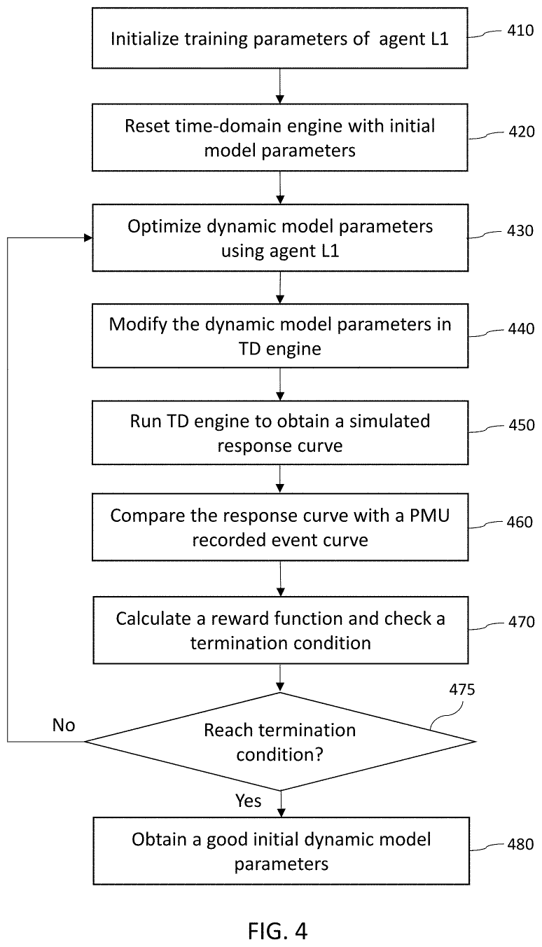

FIG. 4 shows a flowchart illustrating an optimization process by agent L1 shown in FIG. 3. Upon activation, agent L1's training parameters are initialized in step 410. In step 420, the optimization process resets the time-domain engine 160 with initial dynamic model parameters. In step 430, the dynamic model parameters are optimized using agent L1. In step 440, the dynamic model parameters are modified in the TD engine 160. In step 450, the TD engine 160 runs the dynamic model and obtain a simulated response curve. In step 460, the optimization process compares the simulated response curve with a PMU recorded event curve. In step 470, a reward function is calculated and checked against a termination condition which includes that the agent has found a parameter set with error smaller than a predetermined value. The termination condition is indicated in the AI algorithm by a “done” signal. In step 475, if the termination condition has been reached, the optimization process obtains a good initial dynamic model parameters in step 480; otherwise, the optimization process returns to step 430 to further optimize the dynamic model parameter using agent L1. The good initial dynamic model parameters are the parameters instant to the last round of simulation before the termination, and will be used as initial model parameters for agent L2.

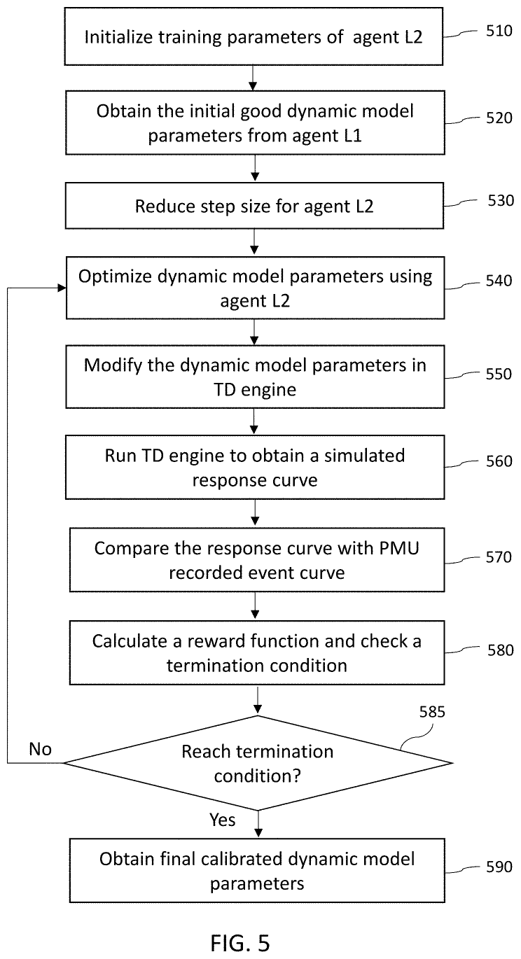

FIG. 5 shows a flowchart illustrating an optimization process by agent L2 shown in FIG. 3. Upon activation, agent L2's training parameters are initialized in step 510. In step 520, the optimization process obtains the initial good dynamic model parameters reached by agent L1. In step 530, the optimization process reduces training step size for agent L2. In step 540, the optimization process optimizes the dynamic model parameters using agent L2 with the reduced step size. In step 550, the dynamic model parameters are modified in the TD engine 160. In step 560, the TD engine 160 runs the dynamic model and obtains a simulated response curve. In step 570, the optimization process compares the simulated response curve with a PMU recorded event curve. In step 580, a reward function is calculated and checked against a termination condition which may be the same as the aforementioned one for agent L1. In step 485, if the termination condition has been reached, the optimization process obtains the final calibrated dynamic model parameters in step 590; otherwise, the optimization process returns to step 540 to further optimize the dynamic model parameter using agent L2.

The embodiments of the present disclosure have following advantages:
Supports a variety of dynamic models in TD simulation engine library;
The agent container is extendable and can accept user-defined algorithms and functions;
The model validation and parameter calibration process are fully automatic; and
Serve multiple objectives, simultaneously consider multiple events and derive optimal parameter sets from random initial conditions as well.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In certain embodiments, a particular software module or component may comprise disparate instructions stored in different locations of a memory device, which together implement the described functionality of the module. Indeed, a module or component may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules or components may be located in local and/or remote memory storage devices. In addition, data being tied or rendered together in a database record may be resident in the same memory device, or across several memory devices, and may be linked together in fields of a record in a database across a network.

Section II. Multi-Layer DRL-Based Parameter Calibration Approaches

As one of the most successful AI methods, deep reinforcement learning (DRL) has been widely used to solve complex power system decision and control problem in time-varying and stochastic environment. Moreover, it has great potential to solve the parameter co-calibration problem considering multi-events that can be formulated as a Markov Decision Process (MDP). Several candidate DRL algorithms exist for solving this problem. In some embodiments of the present disclosure, a value-based method, such as Deep Q Network (DQN), is employed which is simple and computationally efficient but is limited to discrete action space. In some embodiments of the present disclosure, an improved DRL algorithm, soft actor critic (SAC), is employed which can also automate the parameter tuning process for stability models. SAC is an off-policy maximum entropy learning method, based on which the agent can learn to search for the best parameter sets continuously with minimized fitting errors between measured responses and simulated responses from multiple events. In addition, it continues to adaptively update its policy to obtain better parameters until convergence. It's worth mentioning that the proposed method, different from the conventional single-event-oriented parameter calibration approach, can consider multiple events simultaneously in the calibration process. Further, the proposed framework can fulfill multiple objectives, derive optimal parameter sets from random initial conditions and easily adapt to various commercial simulation packages.

2.1 DQN-Based Parameter Calibration

2.1.1 Principles of RL and DQN

An RL agent is trained to maximize the expected cumulative rewards through massive interactions with the environment. The RL agent attempts to learn an optimal policy, represented as a mapping from the system's perceptual states to the agent's actions, using the reward signal in each step. There are four key elements of the reinforcement learning, namely environment, action (a), state (s), and reward (r). The state-action value function is defined as a Q function Q(s, a). Utilizing Q function to find the optimal action selection policy is called Q-learning. The Q(s, a) is updated according to equation (1).

Q(s,a)=Q(s,a)+α(r+γ max Q(s′,a′)−Q(s,a)) (1)

where α is the learning rate, and γ is the discount factor to control the reward. The conventional Q-learning method employs a Q table to represent the values of finite state-action pairs. The optimal action is the action that has the maximum value for a state in the Q table. However, when dealing with an environment that has many actions and states, going through every action in each state to create Q table is both time and space consuming. To avoid using a Q table, one can use a deep neural network with parameter θ to approximate the Q value for all possible actions in each state and minimize the approximation errors. This is the core concept of deep Q network (DQN). The approximation error is the squared difference between the target and the predicted values, defined in equation (2).

L=∥r+γ max Q(s′,a′;θ′)−Q(s,a;θ)∥² (2)

where θ is the network parameter for predicted network and θ′ is the network parameter for the target network. As noted by equation (2), DQN uses a separate network with a fixed parameter θ to estimate the Q target. The target network is frozen for T steps and then parameter θ is copied from the prediction network to the target network to stabilize the training process. Another important technique DQN employs is the experience replay. Instead of direct training with the last transitions (the stored <s,a,r,s′>s,a,r,s′), experience replay decouples correlation among data to reduce overfitting.

Essentially, the parameter calibration problem is a searching and fitting problem. Within a given range, the parameter set can be viewed as a state with a fitting error compared with the reference. By taking an action (either increase or decrease of the current value), the parameter set will move to a new state. The optimal action policy will move the parameter set in a direction with a lower fitting error. This process can be trained with a DRL agent to find the optimal action policy that moves the parameter set from non-optimal to optimal. The detailed design and implementation of each element of a DRL agent is given in the following subsections.

2.1.2 Environment

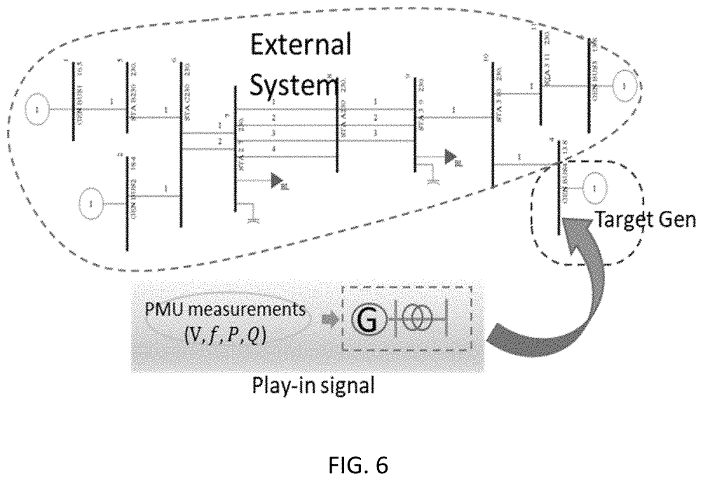

In some embodiments of the present disclosure, the environment is selected as a commercial transient stability simulator, TSAT developed by Powertech Labs as an example, where the DRL agent can get feedback from and evaluate performance of its action. Dynamic simulations with play-in signals containing system events are used to generate model responses when training RL agents (E. Di Mario, Z. Talebpour and A. Martinoli, “A comparison of PSO and Reinforcement Learning for multi-robot obstacle avoidance,” 2013 IEEE Congress on Evolutionary Computation, Cancun, 2013, pp. 149-156). With PMU installed at the generator terminal bus or high-voltage side of the step-up transformer, one can play in voltage magnitude and frequency (or phase angle) information, to generate simulated active and reactive power curves. It is worth mentioning that this function does not to need to explicitly create an external system first for generator model validation and calibration (C. Tsai et al., “Practical Considerations to Calibrate Generator Model Parameters Using Phasor Measurements,” IEEE Trans. Smart Grid, vol. 8, no. 5, pp. 2228-2238, September 2017). The model validation and parameter calibration with “play-in” signals is conceptually illustrated in FIG. 6.

The user-defined environment has the following functions:
Read existing parameters from dynamic data files and send them to DRL agents;
Load play-in signals and invoke a TD engine to perform transient simulations. Although in some embodiments, a TSAT is used, other types of TD engine can also be used to perform this task;
Modify multiple types of dynamic model data files;
Obtain simulation results (i.e., P, Q, V, f) from the TD engine and send them back to agents.

2.1.3 Definition of States and Actions

The DRL agent tends to search for the correct parameter sets in a confined high dimensional space, with exploration and exploitation. In other words, the parameter set that needs to be calibrated can be represented as a state vector S=[s₁, s₂, . . . , sₙ]. At each step, the agent chooses an action a, from the action space A, defined by equations (3) and (4).

A=[A₁,A₂, . . . ,Aᵢ, . . . ,Aₙ] (3)

Aᵢ=[a_{i,1},a_{i,2}, . . . ,a_{i,i}, . . . a_{i,m}] (4)

where n is the number of states, Aᵢ is the action set for the i^{th} state, and a_{i,m} is the m^{th} action for the i^{th} state. The searching process can be formulated as a discrete Markov decision process (MDP). In this particular case, the given range is discretized to small intervals to represent the action a_{i,m} by equation (5).

a_{i,m}=(ρ^{max}−ρ^{min})/N (5)

where N is the total number of action steps, ρ^{max} and ρ^{min} are the maximum and minimum values of the action. After taking the chosen action, the new state vector is updated by equation (6).

S′=S+Aᵢ (6)

2.1.4 Design of Reward Function Considering Multiple Events

A reward is a value the agent received from the environment after taking an action, which is a feedback to reinforce the agent's behavior either in a positive or a negative way. In some embodiments of the present disclosure, the reward for the first level is designed as the negative sum of root mean square error (RMSE) of the active and reactive power responses of a generator for multiple events. The reward for the second level is a negative Hausdorff distance which measures the similarity of two curves (A. A. Taha and A. Hanbury, “An Efficient Algorithm for Calculating the Exact Hausdorff Distance,” IEEE Trans. Pattern Analysis and Machine Intelligence, vol. 37, no. 11, pp. 2153-2163, November 2015) represented by equation (7).

R_{L1}(S′|S,Aᵢ)=−αΣⱼ₌₁ⁿγ_{Li}(Pⱼ)−βΣⱼ₌₁ⁿγ_{Li}(Qⱼ)−γₚ (7)

where j represents the j^{th} recorded event, (Pi) and (Qi) represent the RMSE values and the Hausdorff distances of estimated active and reactive power response mismatch for each level. Intuitively, the reward also measures the parameter fitting error, in a way that the larger the reward, the smaller the fitting error. Moreover, a constant penalty γₚ is added to penalize each additional step the agent takes to speed up the training process.

2.1.5 Dueling DQN (D-DQN) Training Procedure

1) D-DQN algorithm: a more advanced DQN called Dueling DQN (D-DQN) with prioritized experienced replay is adopted for agent training with better convergence and numerical stability. Similar to the DQN mentioned in the previous subsections, the D-DQN also employs two neural networks, a prediction Q network and a separate target network with fixed parameters. Different from the DQN, the Q function of the D-DQN is defined in equation (8).

$$Q ( s , a ) = V ( s ) + A ( s , a ) - \frac{1}{\vert A \vert} {\sum }_{a = 1}^{\vert A \vert} A ( s , a ) \qquad ( 8 )$$

In equation (8), the Q function for the D-DQN is separated into two streams. One stream is V(s), the value function for state s. The other is A(s, a), a state-dependent action advantage function that measures how much better this action is for this state, as compared to the other actions. Then the two streams are combined to get an estimated Q(s,a). Consequently, the D-DQN can learn directly which states are valuable without calculating each action at that state. This is particularly useful when some actions do not affect the environment in a significant way, i.e., adjusting some parameters may not affect the fitting error too much. The D-DQN learns the state-action value function more efficiently and allows a more accurate and stable update.

2) Prioritized experience replay (PER): some experience is more valuable than others but might occur less frequently, so they should not be treated in the same way in the training. For example, only a few parameter sets are capable of showing a similar response as the reference measurements. Embodiments of the present disclosure use PER to provide stochastic prioritization instead of uniformly sampling transitions from experience replay. Further details of PER can be found in V. Mnih, et al., “Human-level control through deep reinforcement learning,” Nature, vol. 518, no. 7540, p. 529, 2015.

3) Decayed ε-greedy policy: in embodiments of the present disclosure, the decayed ε-greedy strategy is employed to balance exploration and exploitation. The updated ε′ from ε in the last iteration is defined by equation (9).

$${ɛ}^{′} = \{ \begin{matrix}{λ}_{d} ɛ & if {ɛ}^{′} \geq {ɛ}_{m i n} \\ {ɛ}_{m i n} & otherwise\end{matrix} \qquad ( 9 )$$

where λ_{d} is the decay factor for ε. The pseudo-code for the proposed D-DQN based training is shown in Algorithm 1.

Algorithm 1 D-DQN Training Procedure

| | |
|---|---|
| 1: | Initialization; γ, ϵ₀, γ_{d}, a, replay memory M, prediction |
| | network Q(s,a;θ) and target network Q(s,a;θ′) |
| 2: | Set up TSAT running environment env ← Run_tsat( ) |
| 3: | for episode in range (n_episodes) do |

| | |
|---|---|
| 4: | s ← env.reset( ) |
| 5: | for steps in itertools.count( ) do |

| | |
|---|---|
| 6: | Update ϵ′ as (10) |
| 7: | θ′ ← θ for every τ step |
| 8: | if rand(1) > ϵ then |

| | |
|---|---|
| 9: | a ← randi(A) |

| | |
|---|---|
| 10: | else |

| | |
|---|---|
| 11: | a ← argmax(Q(s,a;θ)) |

| | |
|---|---|
| 12: | end if |
| 13: | s, s′ r, done ← env.step(a) |
| 14: | Store transition (s, s′, r, a, done) to M |
| 15: | Sample transition batches from M |
| 16: | if done then |

| | |
|---|---|
| 17: | y = r and terminate this episode |

| | |
|---|---|
| 18: | else |

| | |
|---|---|
| 19: | Update Q(s,a;θ) |
| 20: | Update Q(s′,a′,θ′) ← r + γ amax(Q(s,a;θ)) |
| 21: | Calculate loss L , update θ |

| | |
|---|---|
| 22: | end if |
| 23: | s ← s′ |

| | |
|---|---|
| 24: | end for |

| | |
|---|---|
| 25: | end for |

2.1.6 Case Studies Implementing DQN-Based Parameter Calibration

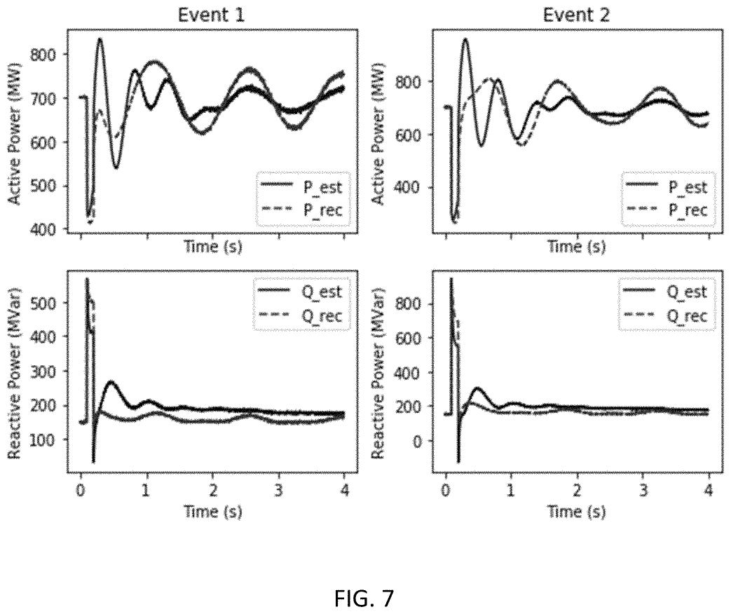

Kundur's two-area system is modified to evaluate the proposed platform. The one-line diagram is shown in FIG. 6. The dynamic models of a power plant to be studied include GENROU (machine), EXAC4A (exciter), STAB1 (PSS) and TGOV1 (governor). One PMU is installed at generator bus 4. Two disturbance events at different operating conditions are considered, with noises in the measurements. With initial parameter sets, a significant mismatch is identified in the model response as shown in FIG. 7. Through sensitivity analysis, five important ones for generator (H, X_{d}′, X_{q}′) and exciter (K_{A}, T_{A}) are identified for calibration. Since no prior information about the initial guess is provided, agents at both levels are trained for faster convergence. The randomly picked initial parameters for generator 4 are shown in Table I, along with their ranges and action step size.

TABLE I
Model parameter and their ranges

| Parameter | Initial Value | Range | Level1 Step | Level2 Step |
|---|---|---|---|---|
| H | 3.00 | [1.0, 10.0] | 1 | 0.01 |
| X′_{d} | 0.50 | [0.0, 1.0] | 0.1 | 0.01 |
| X′_{q} | 0.70 | [0.0, 1.0] | 0.1 | 0.01 |
| K_{A} | 90.0 | [60, 140] | 10 | 1 |
| T_{A} | 0.10 | [0.0, 1.0] | 0.1 | 0.01 |
| Constraint: | X′_{d} < X′_{q} | | | |

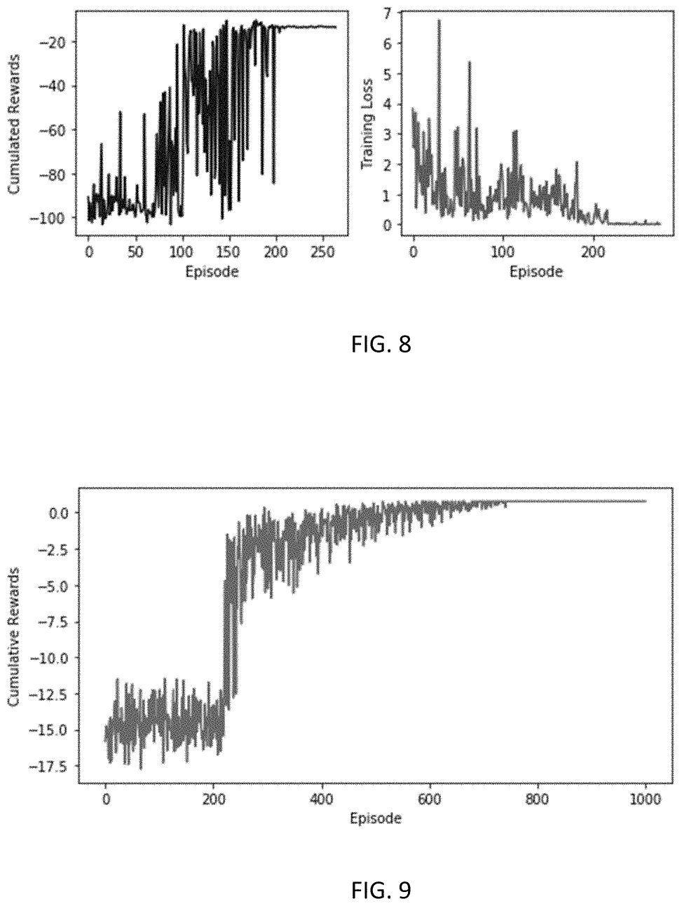

With the initial set of parameters and the given range, agent L1 starts the training process to search for the best initial condition for the preparation of L2 calibration. The training process is shown in FIG. 8, which shows the training converges after 200 episodes and the selected best initial values for the five parameters are [6.0, 0.4, 0.6, 90, 0.0].

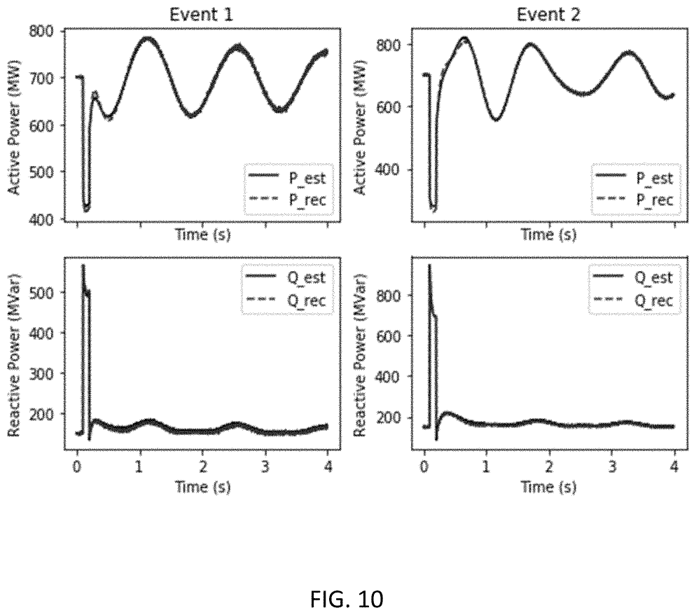

After received initial values, agent L2 starts to search for the best-estimated parameters. The training converges after 800 episode and the cumulative rewards are plotted in FIG. 9.

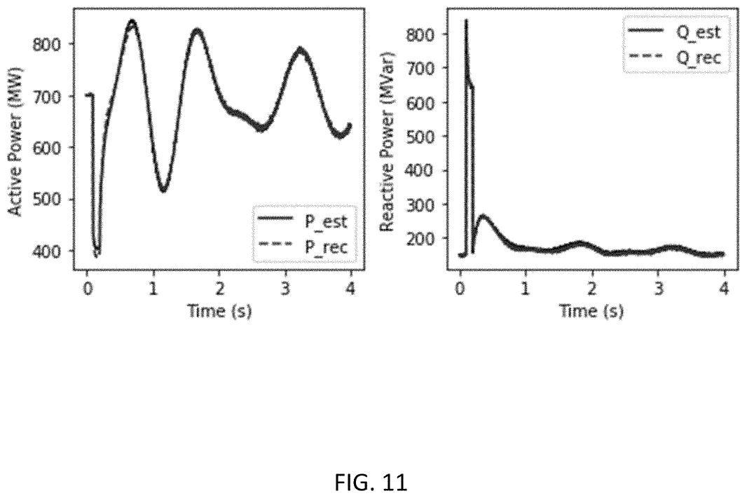

The best parameter set that fits the responses of both events are [6.30, 0.35, 0.59, 92.0, 0.02], which is very close to the true parameter set [6.32, 0.352, 0.553, 100, 0.02]. Dynamic responses of the updated model after parameter calibration are given in FIG. 10.

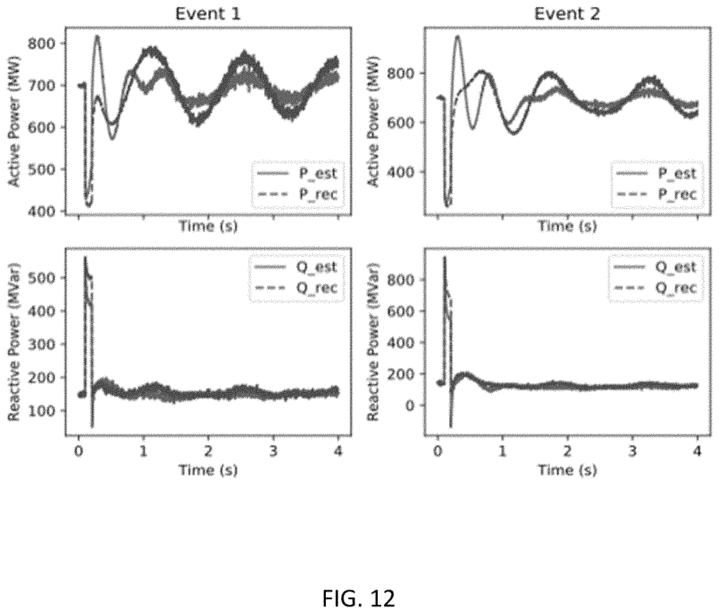

To test the robustness of the calibrated parameters, the third event at Bus 3 is considered here. The active and reactive power transient response with calibrated parameters are plotted in solid lines and the benchmark event curve are plotted in dashed lines in FIG. 11.

In reality, the true model parameters are never known. In some cases especially with larger measurement noises and modeling errors, multiple sets of parameters can describe the main trend of the measurement responses, to different extents. Under this circumstance, the agent may find a number of parameter sets that satisfy the training termination condition. Several modifications and adjustments can be made to select the best parameter set. In this work, five parameter sets are found by the agent. Among those, the one with the smallest RMSE is selected as the best fit. Some other techniques can also be applied towards finding the best one. One solution is to perform reward engineering. For example, one can customize the reward function to capture important features that are more important to grid planners and operators, to better capture the similarity between the measured and the simulated responses, i.e, by penalizing the fitting error on the maximum/minimum points of the trajectories. Adding more layers to further reduce the action step size accordingly is another option. More events may be added as well to narrow down the selection range. Nevertheless, engineering judgment and experience are always important to help resolve the model validation and parameter calibration problem, especially in prescreening of problematic parameters.

2.2 SAC-Based Parameter Co-Calibration

2.2.1 Problem Formation

Basically, the dynamic model parameter calibration problem can be formulated as an MDP, where the RL agent interacts with the environment for multiple steps. At each step, the agent gets the state observation sₜ, and selects an action aₜ. After executing the action, the agent reaches a new state sₜ₊₁ with a probability Pᵣ and receives a reward R. Then the agent can be trained and learn an optimal policy π* that forms a mapping from states to actions for maximizing the cumulative reward. The optimal policy π* is presented in equation (10).

$${π}^{*} = arg {max}_{π} {\sum }_{t} {𝔼}_{( {s}_{t} ; {a}_{t} ) \sim {ρ}_{π}} [ R ( {s}_{t} , {a}_{t} ) ] \qquad ( 10 )$$

Two important functions in standard RL are value function v^{π}(s) and Q function Q^{π}(s, a) represented by equations (11) and (12).

V^{π}(s)= [symbol] (R|sₜ=s;π) (11)

Q^{π}(s,a)= [symbol] (R|sₜ=s,aₜ=a;π) (12)

Variable V^{π}(s) quantifies how good the state s is, which is the cumulative reward the agent can get starting from that state following a policy π. Variable Q^{π}(s, a) evaluates how good an action a is in a state s by calculating the cumulative reward starting from s, taking an action a obtained from policy π.

In this work, the n parameters of a dynamic model can be formulated as a state vector S=[s₁, s₂, . . . sₙ] with a fitting error obtained by comparing the model's active/reactive power responses with those recorded by PMUs. At each step, the agent chooses an action Aₜ based on a certain policy π. By taking the chosen action (either increase or decrease of the current values), the n parameters will transform from the current state to a new state Sₜ₊₁=[s₁′, sₙ′, . . . sₙ′] and the agent will receive a reward R. Through massive interactions with the simulation environment (commercial transient stability simulators without the need of modifying existing models), the agent can be trained to find the optimal action policy π* that maximize the cumulated reward that can tune the parameters towards the state with a lower fitting error along the searching path. The new state after taking an action Aₜ is:

Sₜ₊₁=Sₜ+Aₜ (13)

The reward is a feedback signal the RL agent receives after taking an action to reinforce the agent's behavior either in a positive or a negative way. In this work, it is defined as the negative root mean square error (RMSE) values of estimated active and reactive power response mismatch compared to the active and reactive power curves recorded by PMUs.

R(Sₜ₊₁|Sₜ,Aₜ)=−αΣⱼ₌₁ⁿr(Pⱼ)−βΣⱼ₌₁ⁿr(Qⱼ)−rₛₜₑₚ (14)

where j represents the j^{th} recorded event, r(Pⱼ) and r(Qⱼ) represent the RMSE values of estimated active and reactive power response mismatch. It is important to point out that the information of multiple events are considered simultaneously in the reward formulation. Moreover, a constant penalty factor rₛₜₑₚ is added to penalize each additional step the agent takes, for speeding up the training process. The reward is also used as the evaluation metric for selecting the best-fitting parameters in the later section.

2.2.2 SAC-based Parameter Calibration Procedure

In some embodiments of the present disclosure, the environment is selected as the commercial transient stability simulator, TSAT, developed by Powertech Labs. Dynamic simulations with play-in signals containing system events are used to generate model responses for comparison when training RL agents. A Python interface (Py-TSAT) is developed to automate the entire AI training process.

Similar to standard RL formulation, the SAC also employs value function and Q function. However, standard RL aims to maximize the expected return (sum of rewards) Σₜ E₍ₛ_{ₜ}_{;a}_{ₜ}_{)˜ρ}_{_{π}}[R(sₜ, aₜ)] only, while the SAC trains a stochastic policy with entropy regularization, which means it maximizes not only the expected return but also the entropy of the policy. Then the optimal policy π* is updated using equation (15):

$${π}^{*} = arg {max}_{π} {\sum }_{t} {E}_{( {s}_{t} ; {a}_{t} ) \sim {ρ}_{π}} [ R ( {s}_{t} , {a}_{t} ) + α H ( π \cdot \vert {s}_{t} ) ) ] \qquad ( 15 )$$

where H(π·|sₜ) is the entropy of the policy at state sₜ, and a controls the tradeoff between exploration and exploitation.

Compared to deterministic policy, stochastic policy enables a stronger exploration capability. It is especially useful for parameter calibration problems since typically the feasible solution space is relatively small. Similar to standard RL, policy evaluation and improvement are achieved through training the neural networks with stochastic gradient descent as well. The value function V_{ψ}(sₜ) and the Q-function Q_{θ}(sₜ, aₜ) are parameterized through neural networks with parameters ψ and θ. The soft value function networks are trained to minimize the squared residue error, as shown in equation (16):

J_{V}(ψ)=Eₛ_{ₜ}_{˜D}[(V_{ψ}(sₜ)−V_{soft}(sₜ)]² (16)

with

V_{soft}(sₜ)=E_{α}_{ₜ}_{˜π}[Q_{soft}(sₜ,aₜ)−α log π(aₜ|sₜ) (17)

Also, the soft Q function is trained by minimizing equation (18):

J_{θ}(Q)=E₍ₛ_{ₜ}_{,a}_{ₜ}_{)˜D}[Q_{θ}(sₜ,aₜ)−\hat{Q}(sₜ,aₜ)]² (18)

with

\hat{Q}(sₜ,aₜ)=R(sₜ,aₜ)+γEₛ_{ₜ₊₁}_{˜p}[V_{\hat{ψ}}(sₜ₊₁)] (19)

where V_{\hat{ψ}}(sₜ₊₁) is the target value network that is updated periodically. Different from value and Q functions that are directly modeled with expressive neural networks, the output of the policy neural network follows the Gaussian distribution with mean and covariance. The policy parameters can be learned by minimizing the expected Kullback-Leibler (KL) divergence as equation (20):

$${J}_{π} ( ϕ ) = {D}_{K L} ( π ( . \vert {s}_{t} ) \vert \vert ( exp ( \frac{1}{α} {Q}_{θ} ( {s}_{t} , . ) ) - log Z ( {s}_{t} ) ) = {E}_{{s}_{t} \sim D} [ {E}_{{a}_{t} - {π}_{ϕ}} [ αlog ( {π}_{ϕ} ( {a}_{t} \vert {s}_{t} ) ) - {Q}_{θ} ( {a}_{t} , {s}_{t} ) ] ] \qquad ( 20 )$$

The pseudo-code for the proposed SAC-based parameter calibration is shown in Algorithm 2 below.

Algorithm 2. SAC-based Parameter Calibration Procedure

for k = 1,2... do

for each step do

Observe state s and obtain action a~π(· |sₜ)
Execute a, observe next state sₜ₊₁, reward r and done signal
Store <s,a,r,sₜ₊₁, done> in buffer D
sₜ = sₜ₊₁
if each update condition then

for update times do

Sample a batch <s,a,r,sₜ₊₁,done> from D
Update network Q(s,a): θᵢ ← θᵢ − λᵢ∇J_{Q}(θᵢ)
Update network V(s): ψ ← ψ − λ_{π}∇J_{ν}(ψ)
Update policy network π(s,a): ϕ ← ϕ − λ_{π}∇J_{π}(ϕ)
Update target value network ψ̅ ← τψ̅ + (1 − τ)ψ̅

end for

end if

end for

end for

The implementation details of double Q-function and delayed value function update can be found in V. Mnih, et al., “Human-level control through deep reinforcement learning,” Nature, vol. 518, pp. 529-533, February 2015.

2.2.4 Case Study Implementing SAC-Based Parameter Calibration

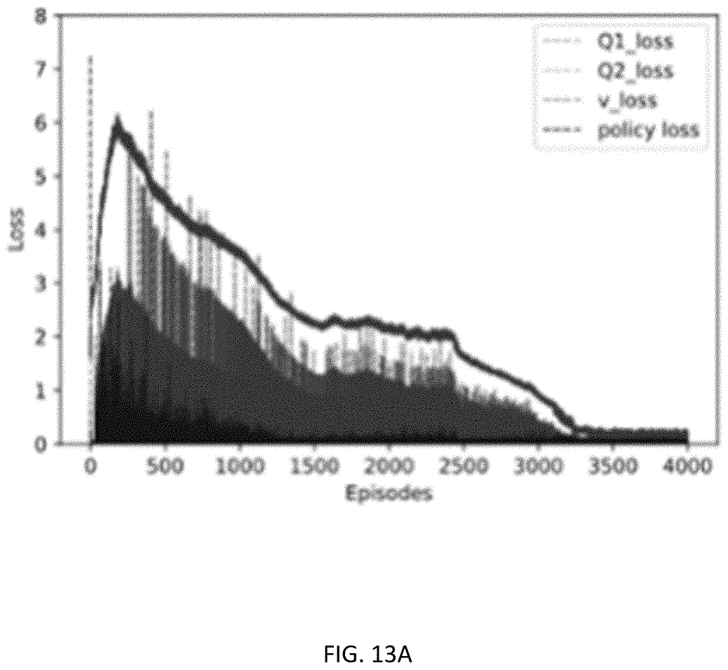

Dynamic models of a power plant to be studied include GENROU, EXAC4A, STAB1 and TGOV1, connected to Bus 4 in Kundur's 2-area system (T. Haarnoja, et al., “Soft actor-critic: off policy maximum entropy deep reinforcement learning with a stochastic actor,” in ICML, vol. 80, Stockholm Sweden, July 2018, pp. 1861-187). One PMU is installed at generator bus 4, where play-in signals are generated. Two disturbance events at different operating conditions are considered, containing measurement noises. Before parameter calibration, a significant mismatch between model response and actual measurements is identified as shown in FIG. 12.

Through sensitivity analysis, five important parameters for both generator (H, X′_{d}, X′_{q}) and exciter (K_{A},T_{A}) are identified for calibration. Since no prior information about the initial parameters is given, we picked the initial model parameters randomly for generator 4 as shown in Table II, along with their ranges and action bounds.

TABLE II
Model parameter and their ranges

| Parameter | Initial Value | Range | Action Bound |
|---|---|---|---|
| H | 3.0 | [1.0, 10.0] | [−2.0, 2.0] |
| X′_{d} | 0.5 | [0.0, 1.0] | [−0.2, 0.2] |
| X′_{q} | 0.7 | [0.0, 1.0] | [−0.2, 0.2] |
| K_{A} | 90 | [60.0, 140.0] | [−2.0, 2.0] |
| T_{A} | 0.1 | [0.0, 1.0] | [−0.2, 0.2] |

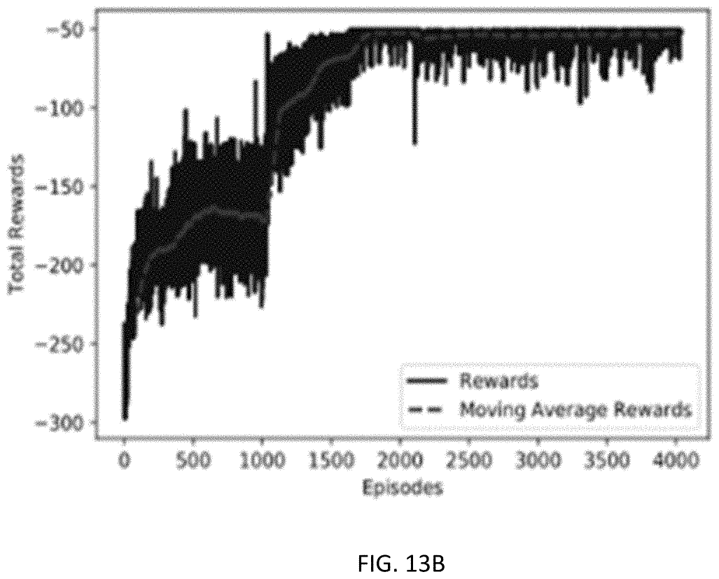

The SAC training results including policy loss, value function loss, and Q function loss are plotted in FIG. 13A.

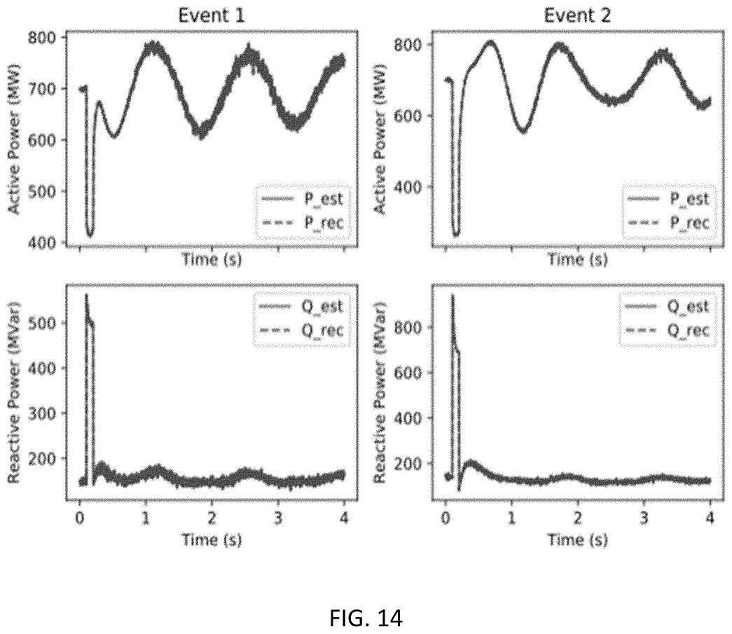

The cumulated reward and the average moving reward are plotted in FIG. 13B. It is shown that the policy converges after 3000 episodes. The top five parameter sets under the converged policy are listed in Table III, and they are all very close to the true parameter set [6.32, 0.352, 0.553, 100.0, 0.02]. In reality, the true model parameters are never known. Multiple model parameter sets may exist that all can capture the main trend of the measurement responses. In this work, the set of parameters with the lowest error is selected as the best ones using evaluation metric. The dynamic responses of the updated model after parameter calibration are given in FIG. 14, which verifies the effectiveness of the proposed method.

TABLE III
Candidate parameter sets

| Rank | H | X′_{d} | X′_{q} | K_{A} | T_{A} | Metric |
|---|---|---|---|---|---|---|
| 1 | 6.2979 | 0.3498 | 0.5592 | 101.93 | 0.0236 | −0.0430 |
| 2 | 6.2484 | 0.3514 | 0.5690 | 99.22 | 0.0119 | −0.0490 |
| 3 | 6.2202 | 0.3532 | 0.5471 | 97.17 | 0.0155 | −0.0669 |
| 4 | 6.3298 | 0.3476 | 0.5589 | 95.06 | 0.0163 | −0.0698 |
| 5 | 6.2126 | 0.3455 | 0.5536 | 101.61 | 0.0194 | −0.0705 |

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

What is claimed is:

1. A method for autonomous parameter calibration for a model of an electric power system, the method comprising:
inputting electric measurements from the electric power system;
simulating the model with a set of parameters to generate a first simulated response;
identifying a first and a second parameter in the set of parameters, the first parameter being responsible for a deviation of the first simulated response from the electric measurements, while the second parameter being not responsible to the deviation;
generating a first action corresponding to the first parameter by a first deep reinforcement learning (DRL) agent based on the deviation;
modifying the first parameter by the generated first action while leaving the second parameter unmodified;
simulating the model again with the set of parameters including the modified first parameter and the unmodified second parameter to generate a second simulated response;
evaluating a first fitting error between the second simulated response and the electric measurements; and
terminating the parameter calibration when the first fitting error falls below a predetermined first threshold.

2. The method of claim 1, wherein electric measurements are measured by phasor measurement units (PMU).

3. The method of claim 1, wherein the electric measurements are associated with multiple events occurred in the electric power system.

4. The method of claim 1, wherein the model is simulated in a time domain simulation engine.

5. The method of claim 1 further comprising providing initial values to the set of parameters by a second DRL agent before activating the first DRL agent, wherein the second DRL agent has a step size larger than that of the first DRL agent.

6. The method of claim 5, wherein the second DRL agent performs:
modifying the first parameter;
simulating the model with the set of parameters including the modified first parameter to generate a third simulated response;
evaluating a second fitting error between the third simulated response and the electric measurements; and
outputting instant values of the set of parameters as the initial values when the second fitting error falls below a predetermined second threshold.

7. The method of claim 6, wherein the evaluating the first or the second fitting error includes calculating a reward function.

8. The method of claim 6, wherein both the first and the second DRL agent include reinforcement learning and training of a neural network.

9. The method of claim 6, wherein both the first and the second DRL agent run a deep Q network (DQN) algorithm.

10. The method of claim 6, wherein both the first and the second DRL agent run a soft actor critic (SAC) algorithm.

11. A system for autonomous parameter calibration for a model of an electric power system, the system comprising:
measurement devices coupled to lines of the electric power system for measuring state information at the lines;
a processor; and
a computer-readable storage medium, comprising:
software instructions executable on the processor to perform operations, including:
inputting electric measurements from the measurement devices;
simulating the model with a set of parameters to generate a first simulated response;
identifying a first and a second parameter in the set of parameters, the first parameter being responsible for a deviation of the first simulated response from the electric measurements, while the second parameter being not responsible to the deviation;
generating a first action corresponding to the first parameter by a first deep reinforcement learning (DRL) agent based on the deviation;
modifying the first parameter by the generated first action while leaving the second parameter unmodified;
simulating the model again with the set of parameters including the modified first parameter and the unmodified second parameter to generate a second simulated response;
evaluating a first fitting error between the second simulated response and the electric measurements; and
terminating the parameter calibration when the first fitting error falls below a predetermined first threshold.

12. The system of claim 11, wherein measurement devices are by phasor measurement units (PMU).

13. The system of claim 11, wherein the electric measurements are associated with multiple events occurred in the electric power system.

14. The system of claim 11, wherein the model is simulated in a time domain simulation engine.

15. The system of claim 11 further comprising providing initial values to the set of parameters by a second DRL agent before activating the first DRL agent, wherein the second DRL agent has a step size larger than that of the first DRL agent.

16. The system of claim 15, wherein the second DRL agent performs:
modifying the first parameter;
simulating the model with the set of parameters including the modified first parameter to generate a third simulated response;
evaluating a second fitting error between the third simulated response and the electric measurements; and
outputting instant values of the set of parameters as the initial values when the second fitting error falls below a predetermined second threshold.

17. The system of claim 16, wherein the evaluating the first or the second fitting error includes calculating a reward function.

18. The system of claim 16, wherein both the first and the second DRL agent include reinforcement learning and training of a neural network.

19. The system of claim 16, wherein both the first and the second DRL agent run a deep Q network (DQN) algorithm.

20. The system of claim 16, wherein both the first and the second DRL agent run a soft actor critic (SAC) algorithm.

21. A method for autonomous parameter calibration for a model of an electric power system, the method comprising:
inputting electric measurements from the electric power system;
activating a first deep reinforcement learning (DRL) agent to optimally adjust a predetermined parameter of a set of parameters for the model with a first action step size;
activating a second DRL agent to further optimally adjust the predetermined parameter with a second action step size smaller than the first action step size; and
terminating the parameter calibration when a fitting error between a model simulated response and the electric measurements falls below a predetermined threshold.

22. The method of claim 21, wherein the predetermined parameter initially causing deviation of a model simulated response from the electric measurements.

23. The method of claim 21, wherein both the first and the second DRL agent run a deep Q network (DQN) algorithm.

24. The method of claim 21, wherein both the first and the second DRL agent run a soft actor critic (SAC) algorithm.
